(19) United States
(12) Patent Application Publication
(10) Pub. No.: US 2012/0058302 A1
(43) Pub. Date: Mar. 8, 2012

(54) FABRICATION OF ANTI-FOULING SURFACES COMPRISING A MICRO- OR NANO-PATTERNED COATING

(75) Inventors: Damien Eggenspieler, Somerville, MA (US); Gozde Ince, Istanbul (TR); Mary C. Boyce, Winchester, MA (US); Karen K. Gleason, Lexington, MA (US)

(73) Assignee: Massachusetts Institute of Technology, Cambridge, MA (US)

(21) Appl. No.: 13/224,633

(22) Filed: Sep. 2, 2011

Related U.S. Application Data
(60) Provisional application No. 61/379,901, filed on Sep. 3, 2010.

(51) Int. Cl. B32B 3/00; B32B 9/00; B32B 15/04; B32B 5/00; B05D 3/12

(52) U.S. Cl. 428/141; 428/332; 427/299; 428/457; 428/689

(57) ABSTRACT

The invention relates to a method of forming a micro- or nano-topography on the surface of a composite material. The topography or the chemical nature of the surface may be modified or tuned. The methods of the invention may be run in a continuous fashion. The composite materials produced by the inventive methods may be micro- or nano-patterned membranes, for instance, for anti-fouling purposes.

### RELATED APPLICATIONS

This application claims the benefit of priority to U.S. Provisional Patent Application Ser. No. 61/379,901, filed Sep. 3, 2010, the contents of which are hereby incorporated by reference.

### BACKGROUND OF THE INVENTION

Surface patterning is an efficient way to improve or optimize the surface properties of materials. Many surface properties, including adhesion, hydrophobicity, adsorption, thermal exchange coefficient, ion transport, and electron transport, are a function of micro-topography. Polymeric coatings on surfaces are typically inexpensive to deposit and versatile, being compatible with applications ranging from antifouling surfaces to sensors.

Micro-patterned surfaces may be fabricated by photolithography, followed by casting of a polymer on the etched surface. This method is not continuous, does not support further modification of surface chemistry, and suffers from limited precision. Alternatively, surface patterning has been achieved by (1) buckling of a stiff coating (e.g., a metallic film) on an elastomeric substrate, or (2) modification of an elastomeric substrate to form a stiff coating. Most of these systems rely on the buckling of homogeneous films on homogeneous substrates with uni-axial or equi-axial stretches, resulting in sinusoidal or Herringbone patterns.

Surfaces with sub-micron patterns experience less fouling, generally, and allow easier removal of spores than other surfaces. Spores may settle in the valleys of longer wrinkles; therefore, patterns with (1) a smaller wavelength than the size of a microorganism, or (2) features of varying sizes are desirable. For example, specific patterns, such as a shark skin pattern, have been shown to be effective for this purpose.

There exists a need for a method of forming micro- or nano-patterned surfaces, wherein the topography or the chemical nature of the surface may be modified or tuned. There also exists a need for a continuous method of production of such materials. A novel method could be used to fabricate micro- or nano-patterned membranes, for instance, for anti-fouling purposes.

### SUMMARY OF THE INVENTION

In certain embodiments, the invention relates to a composite material, wherein the composite material comprises a substrate with a coated surface; and the coated surface comprises a coating material.

In certain embodiments, the invention relates to a method of making a composite material, comprising the steps of:

providing a substrate;

stretching the substrate, thereby forming a stretched substrate;

coating a surface of the stretched substrate with a material, thereby forming a stretched substrate with a coated surface;

releasing the stretch from the stretched substrate with a coated surface, wherein releasing the stretch causes the coated surface to buckle, thereby forming a composite material with a coated surface.

In certain embodiments, the invention relates to a method of making a composite material, comprising the steps of:

providing a substrate;

heating the substrate, thereby forming a heated substrate;

coating a surface of the heated substrate with a material, thereby forming a heated substrate with a coated surface;

allowing the heated substrate with a coated surface to cool, wherein cooling causes the coated surface to buckle, thereby forming a composite material with a coated surface.

### BRIEF DESCRIPTION OF THE FIGURES

FIG. 1 depicts a scheme showing the interplay between topography and chemistry in the development of antifouling coatings; both variables can be independently optimized to improve surface properties.

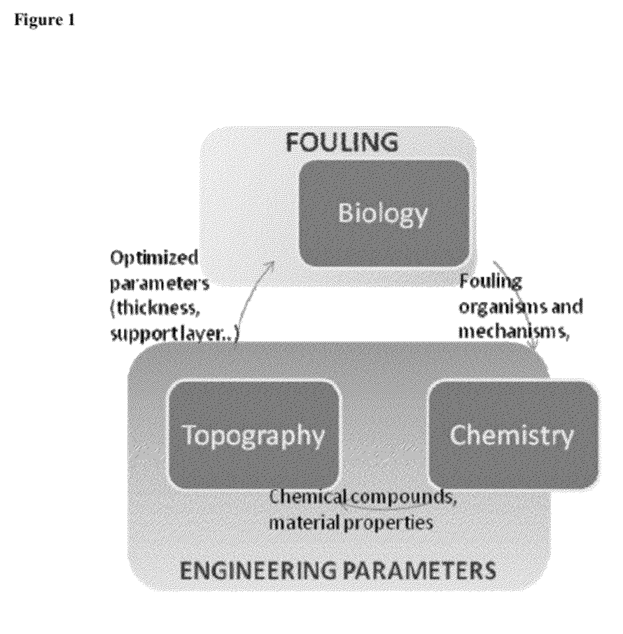

FIG. 2 is a schematic representation of the formation in four steps of a wrinkled substrate: (a) casting of an elastomeric material, (b) stretching of the elastomeric substrate, (c) deposition of a coating, and (d) release of the stretching force resulting in formation of wrinkles.

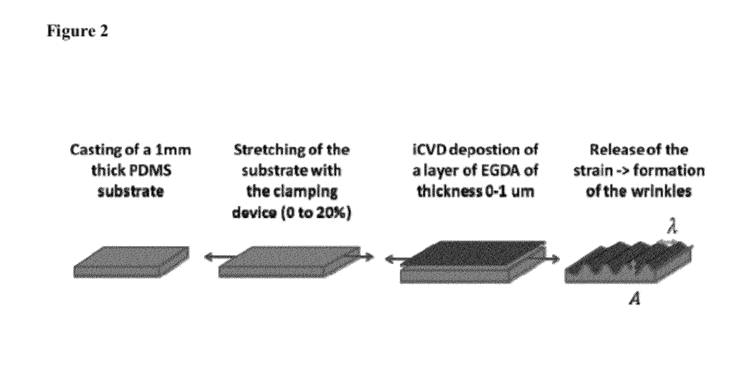

FIG. 3 depicts a “Sharklet” structure produced in poly(dimethylsiloxane) (PDMS) (feature sizes: 2, 4, 8, 12 microns, respectively), and a representation of a shark skin with patterned scales (the size of the scales is dependent on the species).

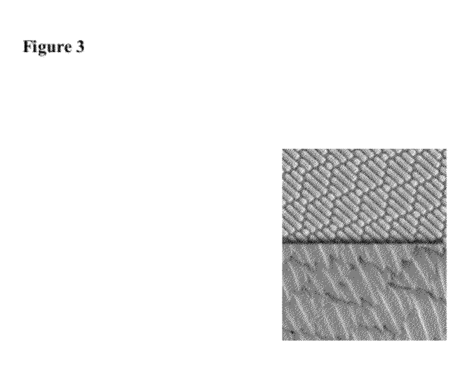

FIG. 4 depicts a continuous fabrication process: a membrane is drawn out of a bath, treated with UV light through a photomask in the form of a belt, coated while the membrane is stretched, and wrapped in a final roll in the unstretched form (i.e., with wrinkles or another desired pattern).

FIG. 5 depicts a roll-to-roll fabrication process. The local treatment can be aided with fiber or particle reinforcement, and the coating applied by initiated chemical vapor deposition (iCVD) or a spraying or evaporation technique. The subsequent release of the strain can be due to a change in the conditions (e.g., humidity, temperature, pH, chemistry) or by removal of a mechanical force.

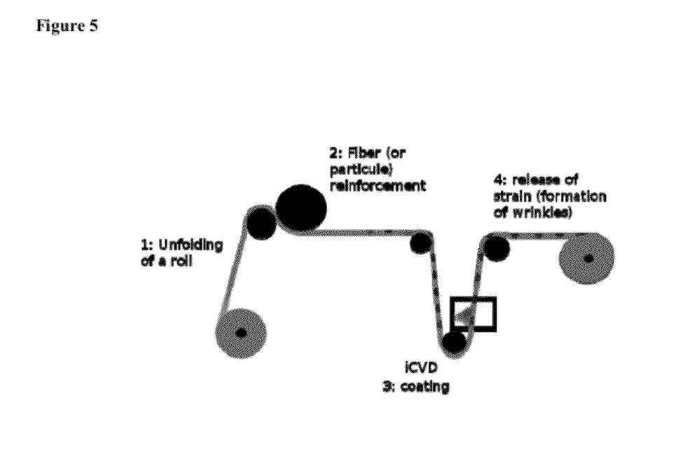

FIG. 6 depicts a schematic showing the formation of a wrinkled substrate in four steps (from top to bottom): (a) stretching of the material (thermal or mechanical), (b) printing of a middle layer (e.g., ink printing), (c) silane treatment and deposition of a coating (e.g., iCVD), and (d) removal of the stretch. Such a method may allow for tuning of the shape of the pattern.

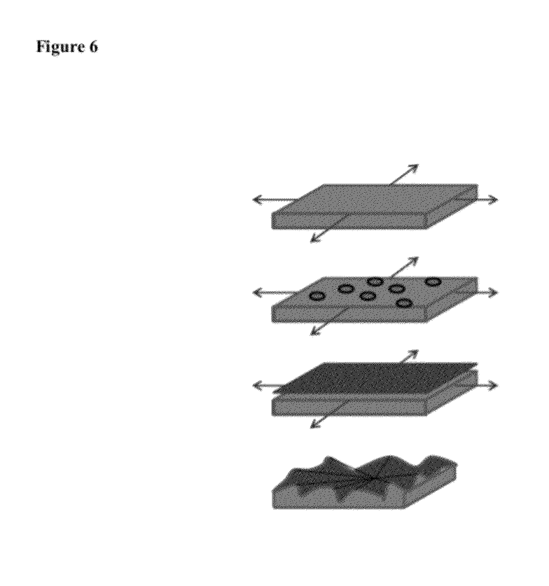

FIG. 7 depicts (a) a microscope image and a profilometer measurement of uncoated PDMS; and (b) microscope images and profilometer measurements of PDMS patterned by an inventive method.

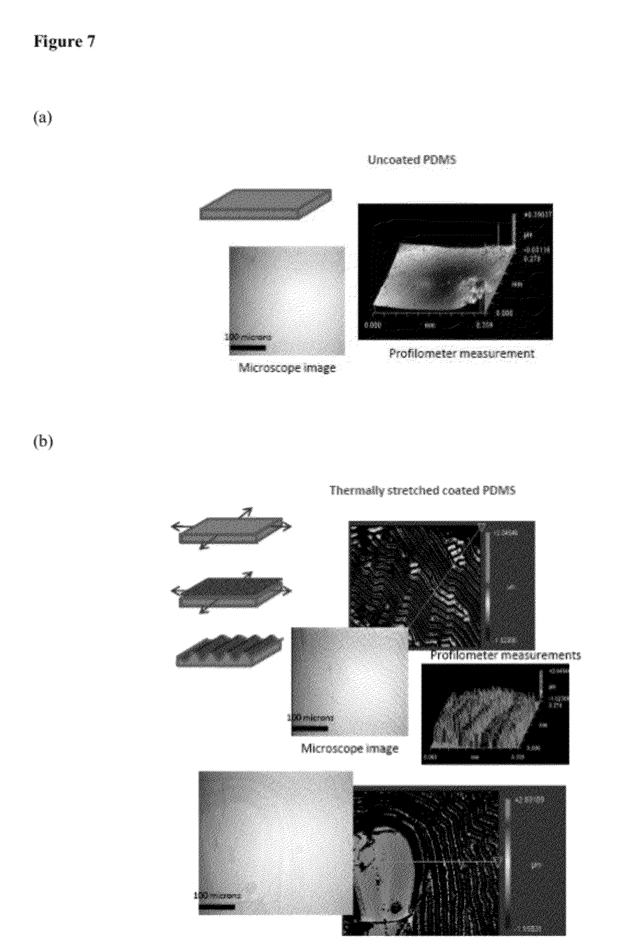

FIG. 8 depicts a curve showing true stress as a function of true strain for PDMS prepared as described in Example 1.

FIG. 9 depicts a graph of the storage modulus of the bulk PDMS as a function of temperature.

FIG. 10 depicts a graph of the thermal strain (corrected by storage modulus) as a function of temperature.

FIG. 11 is a photograph of a sample holder designed to stretch a flexible substrate during coating (for example, coating using initiated chemical vapor deposition (iCVD)).

FIG. 12 depicts schematically an exemplary iCVD coating technique.

FIG. 13 depicts images of a single location on a wrinkled membrane focused on the bottom of the wrinkles (left), the sides of the wrinkles (middle), and the top of the wrinkles (right).

FIG. 14 depicts images of reflected light (left column) and transmitted light (right column) for wrinkles obtained using an optical microscope at magnifications of 5× (top row), 20× (second row), 40× (third row), and 100× (bottom row).

FIG. 15 depicts profilometry images of a stretched sample; 40% strain was applied along the horizontally axis. From top to bottom, the magnification varies from low to high.

FIG. 16 tabulates measurements of the wavelength and amplitude of larger and smaller wrinkles at each of three levels of strain.

FIG. 17 depicts the wavelengths of larger wrinkles as a function of stretch, based on profilometer measurements.

FIG. 18 depicts the amplitudes of larger wrinkles as a function of stretch, based on profilometer measurements.

FIG. 19 tabulates the wavelengths of wrinkles as a function of coating thickness, as measured by optical profilometry.

FIG. 20 depicts profilometry images of the wrinkles for coatings of thicknesses of: (left) 495 nm, where the longest wavelength is measured to be 20 μm, while the orthogonal wavelength is 1.2 μm; and (right) 1000 μm, where the longest wavelength is measured to be 37 μm, while the orthogonal and smaller waves are measured to be 2 μm.

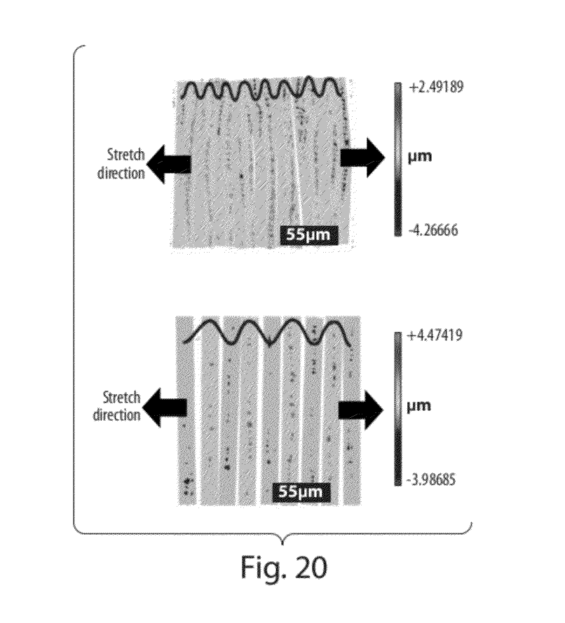

FIG. 21 depicts a micrograph of the wrinkles of an ethylene glycol diacrylate (EGDA) hard coating on top of a PDMS substrate. Low spatial frequency wrinkles run in the direction normal to the stretching (vertical white and gray stripes), while higher frequency wrinkles (horizontal white and gray lines) are perpendicular.

FIG. 22 is an image of a linear defect in a sample. The small wrinkles appear not to be disrupted by the line of defect.

FIG. 23 depicts a schematic of a “numerical inverse design” fabrication method. Calculations may be used to make predictions about the interplay between the fabrication conditions used and the patterns obtained.

FIG. 24 depicts surface wrinkle structures, characterized by its amplitude (A), wavelength (λ) and coating thickness (t) (left). Data comparison among experimental data, computation, and theory (right).

FIG. 25 depicts the effect of pre-stretching strain on amplitude and wavelength of the resulting wrinkling patterns: the comparison between FEM simulation and theory taking account of the finite deformation for amplitude (left) and wavelength (middle) at different prestrain. The simulated wrinkled morphologies are shown at varying prestrain (right)

FIG. 26 depicts the evolution of wrinkling patterns under non-equi-biaxial compression with the strain. (a) Simultaneous loading of the strain in two directions and the ratio of strains is kept to be 2. (b) The same value of strain is applied to the coating film but with a sequential loading, where ε₂ is increased from 0 to 10% whereas ε₁=5% is kept constant.

FIG. 27 depicts various aspects of the invention, including increasingly complex topographies.

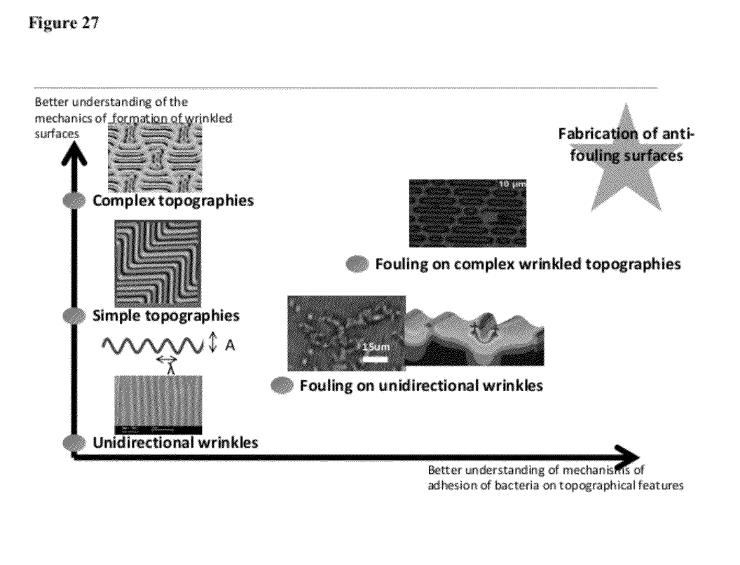

FIG. 28 depicts a comparison between simulated results (right image of each pair) and experimental results (left image of each pair) for substrates stretched bi-axially.

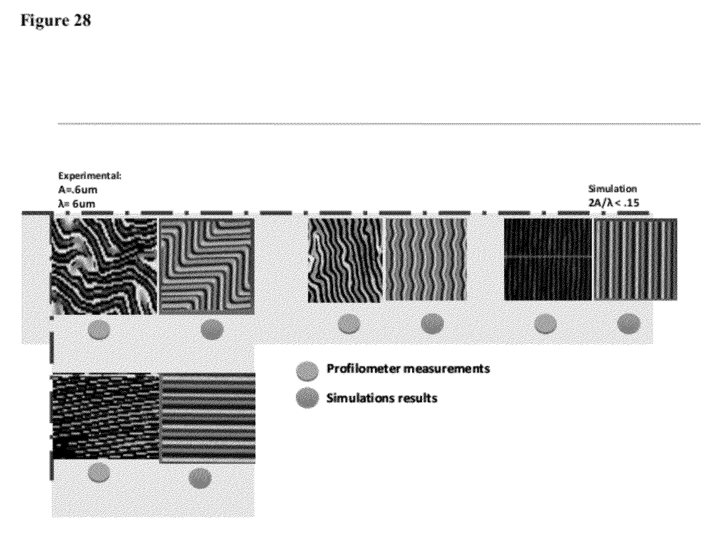

FIG. 29 depicts an example of surface patterning using a substrate with selectively stiffened regions; here, the diamond-shaped region of the substrate was selectively stiffened.

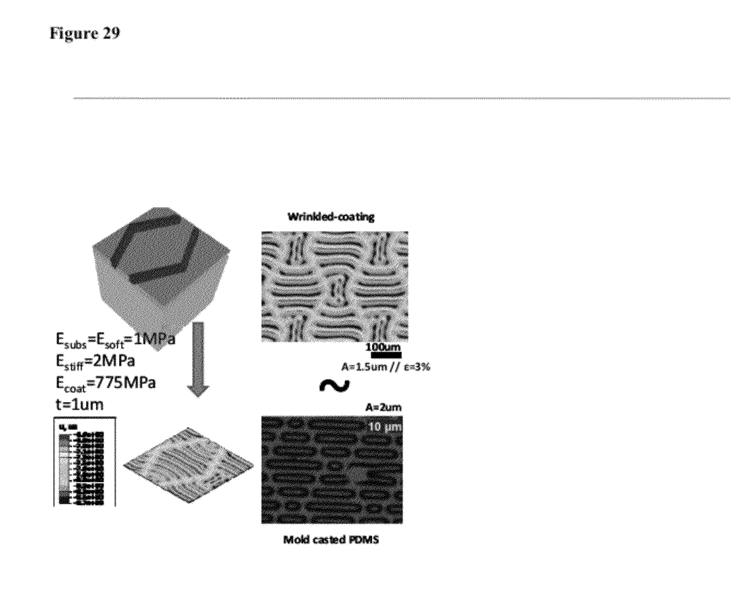

FIG. 30 depicts an example of a fluorescence protocol for fouling experiments.

FIG. 31 depicts various microscopy images taken of samples with adhesions of E. coli (a) 10× magnification, 100 nm thick EGDA coating, 100 ms; (b) 10× magnification, 100 nm thick EGDA coating, 100 ms; (c) 10× magnification, 100 nm thick EGDA coating, 100 ms; (d) 10× magnification, 100 nm thick EGDA coating, 2 ms, rinsed, with backlight; (e) 40× magnification, 100 nm thick EGDA coating, 100 ms, rinsed; and (f) 40× magnification, 100 nm thick EGDA coating, 2 ms, with backlight.

FIG. 32 depicts various microscopy images taken of samples with adhesions of E. coli (a) 10× magnification, 100 nm thick EGDA coating, 100 ms, with backlight; (b) 10× magnification, 100 nm thick EGDA coating, 100 ms, with backlight; (c) 10× magnification, 100 nm thick EGDA coating, 2 ms, with backlight; (d) 40× magnification, 100 nm thick EGDA coating, 100 ms; (e) 40× magnification, 100 nm thick EGDA coating, 100 ms, fluorescence, rinsed; and (f) 40× magnification, 100 nm thick EGDA coating, 2 ms, rinsed, with backlight.

### DETAILED DESCRIPTION OF THE INVENTION

### Overview

In certain embodiments, the invention relates to a method of forming a micro- or nano-topography. In certain embodiments, the invention relates to a method of forming a desired micro- or nano-topography; wherein the material used to form the micro- or nano-topography is able to be chemically manipulated. In certain embodiments, the method enables the rapid processing of large quantities of patterned substrates. In certain embodiments, the method involves buckling of a stiff coating under compression on top of a compliant substrate. In certain embodiments, the method is compatible with a wide variety of chemical compounds.

In certain embodiments, the methods described herein may influence the shape of an object by changing its material properties. In certain embodiments, active materials (which can reversibly change their mechanical properties with temperature, light, or magnetic and chemical signals) can be used in combination with this design method to produce structures that can change shape—this technology should benefit numerous fields, including bio-chips, microfluidic devices, and MEMS fabrication.

In certain embodiments, the invention relates to a composite material. In certain embodiments, the composite material is a membrane.

### Exemplary Materials

In certain embodiments, the invention relates to a composite material, wherein the composite material comprises a substrate with a coated surface; and the coated surface comprises a coating material.

In certain embodiments, the invention relates to any one of the aforementioned composite materials, wherein the coated surface is contiguous to the substrate.

In certain embodiments, the invention relates to any one of the aforementioned composite materials, wherein the coated surface is not topographically smooth. In certain embodiments, the invention relates to any one of the aforementioned composite materials, wherein the coated surface comprises topography. In certain embodiments, the invention relates to any one of the aforementioned composite materials, wherein the coated surface comprises a topographic pattern. In certain embodiments, the invention relates to any one of the aforementioned composite materials, wherein the topographic pattern is three-dimensional. In certain embodiments, the invention relates to any one of the aforementioned composite materials, wherein the topographic pattern is periodic. In certain embodiments, the invention relates to any one of the aforementioned composite materials, wherein the topographic pattern is sinusoidal. In certain embodiments, the invention relates to any one of the aforementioned composite materials, wherein the topographic pattern is a sharklet pattern. In certain embodiments, the invention relates to any one of the aforementioned composite materials, wherein the topographic pattern has at least two different periodic patterns, a first periodic pattern and a second periodic pattern. In certain embodiments, the invention relates to any one of the aforementioned composite materials, wherein the first periodic pattern and the second periodic pattern are oriented in the same direction. In certain embodiments, the invention relates to any one of the aforementioned composite materials, wherein the first periodic pattern and the second periodic pattern are oriented in different directions.

In certain embodiments, the features of the topographic pattern are on the order of micrometers or nanometers. In certain embodiments, the optimal feature size is to be specific to the fouling species. For example, micron-sized features (for example, wavelengths) may be useful for preventing the adhesion of spores for marine uses. Alternatively, smaller feature sizes (e.g., 10 nm) may be used to prevent adhesion of a polysaccharide biofilm.

In certain embodiments, the invention relates to any one of the aforementioned composite materials, wherein the substrate is homogeneous.

In certain embodiments, the invention relates to any one of the aforementioned composite materials, wherein the substrate is heterogeneous. In certain embodiments, the substrate is heterogeneous through its thickness. In certain embodiments, the substrate is heterogeneous across its surface. In certain embodiments, the invention relates to any one of the aforementioned composite materials, wherein the substrate is a composite. In certain embodiments, the invention relates to any one of the aforementioned composite materials, wherein the substrate is reinforced with an organic or non-organic substance.

In certain embodiments, the invention relates to any one of the aforementioned composite materials, wherein the substrate is porous.

In certain embodiments, the invention relates to any one of the aforementioned composite materials, wherein the substrate is soft. In certain embodiments, the invention relates to any one of the aforementioned composite materials, wherein the substrate is pliable.

In certain embodiments, the invention relates to any one of the aforementioned composite materials, wherein the substrate comprises an elastomeric material or a thermoplastic material. In certain embodiments, the invention relates to any one of the aforementioned composite materials, wherein the substrate is a thermoplastic elastomer, a crosslinked elastomer, or a filled elastomer. In certain embodiments, the invention relates to any one of the aforementioned composite materials, wherein the substrate comprises a silicone. In certain embodiments, the invention relates to any one of the aforementioned composite materials, wherein the substrate comprises poly(dimethylsiloxane).

In certain embodiments, the invention relates to any one of the aforementioned composite materials, wherein the substrate comprises an elastomeric material; and the elastomeric material is selected from the group consisting of polyisoprene, polybutadiene, polychloroprene, isobutylene-isoprene copolymers, styrene-butadiene copolymers, butadiene-acrylonitrile copolymers, ethylene-propylene copolymers, and ethylene-vinyl acetate copolymers.

In certain embodiments, the invention relates to any one of the aforementioned composite materials, wherein the substrate comprises a thermoplastic elastomer; and the thermoplastic elastomer is a styrenic block copolymer, a polyolefin blend, an elastomeric alloy, a thermoplastic polyurethane, a thermoplastic copolyester, or thermoplastic polyamide.

In certain embodiments, the invention relates to any one of the aforementioned composite materials, wherein the substrate comprises a thermoplastic polymer or a thermoplastic material at or near the glass transition region.

In certain embodiments, the invention relates to any one of the aforementioned composite materials, wherein the substrate comprises a thermoplastic material; and the thermoplastic material is selected from the group consisting of an acrylonitrile-butadiene-styrene copolymer, a polyacrylate (such as poly(methyl methacrylate)), a celluloid, cellulose acetate, a cyclic olefin copolymer, an ethylene-vinyl acetate copolymer, an ethylene-vinyl alcohol copolymer, a fluoroplastic (such as poly tetrafluoroethylene), an ionomer, polyoxymethylene, polyacrylonitrile, polyamide, polyamide-imide, polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyester, polyethylene, polyetheretherketone, polyetherketoneketone, polyetherimide, polyethersulfones, chlorinated polyethylene, polyimide, polylactic acid, polymethylpentene, polyphenylene oxide, polyphenylene sulfide, polyphthalamide, polypropylene, polystyrene, polysulfones, polytrimethylene terephthalate, polyurethane, polyvinyl acetate, polyvinyl chloride, and styrene-acrylonitrile copolymers.

In certain embodiments, the invention relates to any one of the aforementioned composite materials, wherein the substrate is non-uniform. Non-uniformities (for example, in the stiffness of the substrate or in its topography) can be generated by altering the material properties of the bulk substrate (e.g., locally changing the cross-link density of an elastomeric material, or altering the distribution of the molecules via electromagnetic fields) or by changing the physical properties of more complex materials (e.g., non-uniform porosity of a material, or alignment of fibers in given directions). In certain embodiments, the substrate may be of non-uniform thickness.

In certain embodiments, the invention relates to any one of the aforementioned composite materials, wherein the coating material is hard. In certain embodiments, the invention relates to any one of the aforementioned composite materials, wherein the coating material is stiff. In certain embodiments, the invention relates to any one of the aforementioned composite materials, wherein the coating material is stiff in comparison to the substrate.

In certain embodiments, the invention relates to any one of the aforementioned composite materials, wherein the coating material comprises a polymer. In certain embodiments, the invention relates to any one of the aforementioned composite materials, wherein the coating material comprises a cross-linked polymer. In certain embodiments, the invention relates to any one of the aforementioned composite materials, wherein the coating material comprises a fluoropolymer. In certain embodiments, the invention relates to any one of the aforementioned composite materials, wherein the coating material comprises a vinyl polymer. In certain embodiments, the invention relates to any one of the aforementioned composite materials, wherein the coating material comprises poly(ethylene glycol diacrylate) or poly(ethylene glycol dimethacrylate).

In certain embodiments, the invention relates to any one of the aforementioned composite materials, wherein the coating material comprises a thermoplastic material; and the thermoplastic material is selected from the group consisting of an acrylonitrile-butadiene-styrene copolymer, a polyacrylate (such as poly(methyl methacrylate)), a celluloid, cellulose acetate, a cyclic olefin copolymer, an ethylene-vinyl acetate copolymer, an ethylene-vinyl alcohol copolymer, a fluoroplastic (such as poly tetrafluoroethylene), an ionomer, polyoxymethylene, polyacrylonitrile, polyamide, polyamide-imide, polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyester, polyethylene, polyetheretherketone, polyetherketoneketone, polyetherimide, polyethersulfones, chlorinated polyethylene, polyimide, polylactic acid, polymethylpentene, polyphenylene oxide, polyphenylene sulfide, polyphthalamide, polypropylene, polystyrene, polysulfones, polytrimethylene terephthalate, polyurethane, polyvinyl acetate, polyvinyl chloride, and styrene-acrylonitrile copolymers.

In certain embodiments, the invention relates to any one of the aforementioned composite materials, wherein the coating material comprises a metal. In certain embodiments, the invention relates to any one of the aforementioned composite materials, wherein the coating material comprises gold.

In certain embodiments, the invention relates to any one of the aforementioned composite materials, wherein the coating material comprises polystyrene.

In certain embodiments, the invention relates to any one of the aforementioned composite materials, wherein the coating material comprises a ceramic. In certain embodiments, the invention relates to any one of the aforementioned composite materials, wherein the coating material comprises a ceramic composite material.

In certain embodiments, the invention relates to any one of the aforementioned composite materials, wherein the coating material comprises any polymer or polymer-based composite that is comparatively stiffer than the substrate. In certain embodiments, the invention relates to any one of the aforementioned composite materials, wherein the coating material is any material with anti-fouling characteristics.

In certain embodiments, the invention relates to any one of the aforementioned composite materials, wherein the thickness of the coating material is uniform. In certain embodiments, the invention relates to any one of the aforementioned composite materials, wherein the thickness of the coating material is from about 0.005 μm to about 500 μm. In certain embodiments, the invention relates to any one of the aforementioned composite materials, wherein the thickness of the coating material is from about 0.01 μm to about 100 μm. In certain embodiments, the invention relates to any one of the aforementioned composite materials, wherein the thickness of the coating material is about 0.1 μm, about 0.2 μm, about 0.3 μm, about 0.4 μm, about 0.5 μm, about 0.6 μm, about 0.7 μm, about 0.8 μm, about 0.9 μm, about 1.0 μm, about 2.0 μm, about 3.0 μm, about 4.0 μm, about 5.0 μm, about 10.0 μm, about 20.0 μm, about 30.0 μm, about 40.0 μm, about 50.0 μm, about 60.0 μm, about 70.0 μm, about 80.0 μm, about 90.0 μm, or about 100 μm.

In certain embodiments, the invention relates to any one of the aforementioned composite materials, wherein the coating material is covalently grafted to the substrate.

In certain embodiments, the invention relates to any one of the aforementioned composite materials, wherein the coated surface is ambiphilic. In certain embodiments, the invention relates to any one of the aforementioned composite materials, wherein the coated surface is zwitterionic.

In certain embodiments, the invention relates to any one of the aforementioned composite materials, wherein the composite material exhibits anti-fouling properties.

In certain embodiments, the invention relates to any one of the aforementioned composite materials, wherein the composite material is a membrane. In certain embodiments, the invention relates to any one of the aforementioned composite materials, wherein the composite material is a permeable membrane.

### Exemplary Methods

In certain embodiments, the invention relates to a method of making a composite material, comprising the steps of:

providing a substrate;

stretching the substrate, thereby forming a stretched substrate;

coating a surface of the stretched substrate with a material, thereby forming a stretched substrate with a coated surface;

releasing the stretch from the stretched substrate with a coated surface, wherein releasing the stretch causes the coated surface to buckle, thereby forming a composite material with a coated surface.

In certain embodiments, the invention relates to a method of making a composite material, comprising the steps of:

providing a substrate;

heating the substrate, thereby forming a heated substrate;

coating a surface of the heated substrate with a material, thereby forming a heated substrate with a coated surface;

allowing the heated substrate with a coated surface to cool, wherein cooling causes the coated surface to buckle, thereby forming a composite material with a coated surface.

In certain embodiments, the invention relates to any one of the aforementioned methods, further comprising the step of irradiating a portion of the substrate, thereby forming a modified substrate. In certain embodiments, the substrate is irradiated before stretching. In certain embodiments, the substrate is irradiated before heating. In certain embodiments, the substrate is irradiated after stretching. In certain embodiments, the substrate is irradiated after heating.

In certain embodiments, the invention relates to any one of the aforementioned methods, further comprising the step of contacting the substrate with a particle or fiber, thereby forming a modified substrate. In certain embodiments, the substrate is contacted with a particle or fiber before stretching. In certain embodiments, the substrate is contacted with a particle or fiber before heating. In certain embodiments, the substrate is contacted with a particle or fiber after stretching. In certain embodiments, the substrate is contacted with a particle or fiber after heating.

In certain embodiments, the invention relates to any one of the aforementioned methods, further comprising the step of exposing a surface of the substrate to plasma. In certain embodiments, the surface of the substrate is exposed to plasma before stretching. In certain embodiments, the surface of the substrate is exposed to plasma before heating. In certain embodiments, the surface of the substrate is exposed to plasma after stretching. In certain embodiments, the surface of the substrate is exposed to plasma after heating.

In certain embodiments, the invention relates to any one of the aforementioned methods, further comprising the step of contacting a surface of the substrate with gaseous silane. In certain embodiments, the surface of the substrate is contacted with gaseous silane before stretching. In certain embodiments, the surface of the substrate is contacted with gaseous silane before heating. In certain embodiments, the surface of the substrate is contacted with gaseous silane after stretching. In certain embodiments, the surface of the substrate is contacted with gaseous silane after heating. In certain embodiments, the surface of the substrate is contacted with gaseous silane after being exposed to plasma.

In certain embodiments, the invention relates to any one of the aforementioned methods, further comprising the step of functionalizing the surface of the composite material with the coated surface.

In certain embodiments, the invention relates to a method of making a composite material, comprising the steps of:

providing a substrate;

stretching the substrate, thereby forming a stretched substrate;

exposing a surface of the stretched substrate to plasma, thereby forming a stretched substrate with an enhanced number of radical species on its surface;

contacting with gaseous silane the surface of the stretched substrate enhanced in radical species;

coating the surface of the stretched substrate with a material, thereby forming a stretched substrate with a coated surface;

releasing the stretch from the stretched substrate with a coated surface, wherein releasing the stretch causes the coated surface to buckle, thereby forming a composite material with a coated surface.

In certain embodiments, the invention relates to a method of making a composite material, comprising the steps of:

providing a substrate;

exposing a surface of the substrate to plasma, thereby forming a substrate with an enhanced number of radical species on its surface;

contacting with gaseous silane the surface of the substrate enhanced in radical species;

stretching the substrate, thereby forming a stretched substrate;

coating the surface of the stretched substrate with a material, thereby forming a stretched substrate with a coated surface;

releasing the stretch from the stretched substrate with a coated surface, wherein releasing the stretch causes the coated surface to buckle, thereby forming a composite material with a coated surface.

In certain embodiments, the invention relates to any one of the aforementioned methods, wherein the substrate is stretched uni-axially or bi-axially.

In certain embodiments, the invention relates to any one of the aforementioned methods, wherein the substrate is stretched from about 0.01% to about 100%. In certain embodiments, the invention relates to any one of the aforementioned methods, wherein the substrate is stretched from about 0.01% to about 25%. In certain embodiments, the substrate is stretched about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20%. In certain embodiments, the substrate is stretched in one dimension, two dimensions, or three dimensions. In certain embodiments, the degree of stretching in a substrate relates to the amplitude of the waves created in the final composite material, or the height of the features. In certain embodiments, PDMS may be stretched up to about 100%; in certain embodiments, this would provide a feature size with a ratio of about 1:1 (feature length:feature height).

In certain embodiments, the invention relates to any one of the aforementioned methods, further comprising the step of releasing at least a portion of the stretch from the stretched substrate during the coating step.

In certain embodiments, the invention relates to any one of the aforementioned methods, wherein the coated surface of the composite material is not topographically smooth. In certain embodiments, the invention relates to any one of the aforementioned methods, wherein the coated surface of the composite material comprises topography. In certain embodiments, the invention relates to any one of the aforementioned methods, wherein the coated surface of the composite material comprises a topographic pattern. In certain embodiments, the invention relates to any one of the aforementioned methods, wherein the topographic pattern is three-dimensional. In certain embodiments, the invention relates to any one of the aforementioned methods, wherein the topographic pattern is sinusoidal. In certain embodiments, the invention relates to any one of the aforementioned methods, wherein the topographic pattern is a sharklet pattern.

In certain embodiments, the invention relates to any one of the aforementioned methods, wherein the substrate is homogeneous.

In certain embodiments, the invention relates to any one of the aforementioned methods, wherein the substrate is heterogeneous. In certain embodiments, the substrate is heterogeneous through its thickness. In certain embodiments, the substrate is heterogeneous across its surface.

In certain embodiments, the invention relates to any one of the aforementioned methods, wherein the substrate is porous.

In certain embodiments, the invention relates to any one of the aforementioned methods, wherein the substrate is soft. In certain embodiments, the invention relates to any one of the aforementioned methods, wherein the substrate is pliable.

In certain embodiments, the invention relates to any one of the aforementioned methods, wherein the substrate comprises an elastomeric material or a thermoplastic material. In certain embodiments, the invention relates to any one of the aforementioned methods, wherein the substrate is a thermoplastic elastomer, a crosslinked elastomer, or a filled elastomer. In certain embodiments, the invention relates to any one of the aforementioned methods, wherein the substrate comprises a silicone. In certain embodiments, the invention relates to any one of the aforementioned methods, wherein the substrate comprises poly(dimethylsiloxane).

In certain embodiments, the invention relates to any one of the aforementioned methods, wherein the substrate comprises an elastomeric material; and the elastomeric material is selected from the group consisting of polyisoprene, polybutadiene, polychloroprene, isobutylene-isoprene copolymers, styrene-butadiene copolymers, butadiene-acrylonitrile copolymers, ethylene-propylene copolymers, and ethylene-vinyl acetate copolymers.

In certain embodiments, the invention relates to any one of the aforementioned methods, wherein the substrate comprises a thermoplastic polymer or a thermoplastic material at or near the glass transition region.

In certain embodiments, the invention relates to any one of the aforementioned methods, wherein the substrate comprises a thermoplastic material; and the thermoplastic material is selected from the group consisting of an acrylonitrile-butadiene-styrene copolymer, a polyacrylate (such as poly(methyl methacrylate)), a celluloid, cellulose acetate, a cyclic olefin copolymer, an ethylene-vinyl acetate copolymer, an ethylene-vinyl alcohol copolymer, a fluoroplastic (such as poly tetrafluoroethylene), an ionomer, polyoxymethylene, polyacrylonitrile, polyamide, polyamide-imide, polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyester, polyethylene, polyetheretherketone, polyetherketoneketone, polyetherimide, polyethersulfones, chlorinated polyethylene, polyimide, polylactic acid, polymethylpentene, polyphenylene oxide, polyphenylene sulfide, polyphthalamide, polypropylene, polystyrene, polysulfones, polytrimethylene terephthalate, polyurethane, polyvinyl acetate, polyvinyl chloride, and styrene-acrylonitrile copolymers.

In certain embodiments, the invention relates to any one of the aforementioned methods, wherein the substrate is non-uniform. Non-uniformities (for example, in the stiffness of the substrate or in its topography) can be generated by altering the material properties of the bulk substrate (e.g., locally changing the cross-link density of an elastomeric material, or altering the distribution of the molecules via electromagnetic fields) or by changing the physical properties of more complex materials (e.g., non-uniform porosity of a material, or alignment of fibers in given directions). In certain embodiments, non-uniformities in the substrate are formed by irradiating a portion of the substrate, as described above.

In certain embodiments, the invention relates to any one of the aforementioned methods, wherein coating the surface of the substrate comprises initiated chemical vapor deposition (iCVD) of a polymer in a deposition chamber. In certain embodiments, the pressure of the deposition chamber is from about 0.05 Torr to about 1.5 Torr. In certain embodiments, the pressure of the deposition chamber is about 0.1 Torr, about 0.2 Torr, about 0.3 Torr, about 0.4 Torr, about 0.5 Torr, about 0.6 Torr, about 0.7 Torr, about 0.8 Torr, about 0.9 Torr, or about 1.0 Torr.

In certain embodiments, the invention relates to any one of the aforementioned methods, wherein coating the surface of the substrate comprises contacting the surface with a polymer solution.

In certain embodiments, the invention relates to any one of the aforementioned methods, wherein the coating material is hard. In certain embodiments, the invention relates to any one of the aforementioned methods, wherein the coating material is stiff. In certain embodiments, the invention relates to any one of the aforementioned methods, wherein the coating material is stiff in comparison to the substrate.

In certain embodiments, the invention relates to any one of the aforementioned methods, wherein the coating material comprises a polymer. In certain embodiments, the invention relates to any one of the aforementioned methods, wherein the coating material comprises poly(ethylene glycol diacrylate) or poly(ethylene glycol dimethacrylate).

In certain embodiments, the invention relates to any one of the aforementioned methods, wherein the coating material comprises a thermoplastic material; and the thermoplastic material is selected from the group consisting of an acrylonitrile-butadiene-styrene copolymer, a polyacrylate (such as poly(methyl methacrylate)), a celluloid, cellulose acetate, a cyclic olefin copolymer, an ethylene-vinyl acetate copolymer, an ethylene-vinyl alcohol copolymer, a fluoroplastic (such as poly tetrafluoroethylene), an ionomer, polyoxymethylene, polyacrylonitrile, polyamide, polyamide-imide, polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyester, polyethylene, polyetheretherketone, polyetherketoneketone, polyetherimide, polyethersulfones, chlorinated polyethylene, polyimide, polylactic acid, polymethylpentene, polyphenylene oxide, polyphenylene sulfide, polyphthalamide, polypropylene, polystyrene, polysulfones, polytrimethylene terephthalate, polyurethane, polyvinyl acetate, polyvinyl chloride, and styrene-acrylonitrile copolymers.

In certain embodiments, the invention relates to any one of the aforementioned methods, wherein the coating material comprises a metal. In certain embodiments, the invention relates to any one of the aforementioned methods, wherein the coating material comprises gold.

In certain embodiments, the invention relates to any one of the aforementioned methods, wherein the coating material comprises polystyrene.

In certain embodiments, the invention relates to any one of the aforementioned methods, wherein the coating material comprises a ceramic. In certain embodiments, the invention relates to any one of the aforementioned methods, wherein the coating material comprises a ceramic composite material.

In certain embodiments, the invention relates to any one of the aforementioned methods, wherein the coating material comprises any polymer or polymer-based composite that is comparatively stiffer than the substrate. In certain embodiments, the invention relates to any one of the aforementioned methods, wherein the coating material is any material with anti-fouling characteristics.

In certain embodiments, the invention relates to any one of the aforementioned methods, wherein the thickness of the coating material is from about 0.005 μm to about 500 μm. In certain embodiments, the invention relates to any one of the aforementioned methods, wherein the thickness of the coating material is from about 0.01 μm to about 100 μm. In certain embodiments, the invention relates to any one of the aforementioned methods, wherein the thickness of the coating material is about 0.1 μm, about 0.2 μm, about 0.3 μm, about 0.4 μm, about 0.5 μm, about 0.6 μm, about 0.7 μm, about 0.8 μm, about 0.9 μm, about 1.0 μm, about 2.0 μm, about 3.0 μm, about 4.0 μm, about 5.0 μm, about 10.0 μm, about 20.0 μm, about 30.0 μm, about 40.0 μm, about 50.0 μm, about 60.0 μm, about 70.0 μm, about 80.0 μm, about 90.0 μm, or about 100 μm.

In certain embodiments, mathematical or mechanical models may be used to calculate the parameters necessary to create desired patterns, shapes, and sizes on the surface of the composite material.

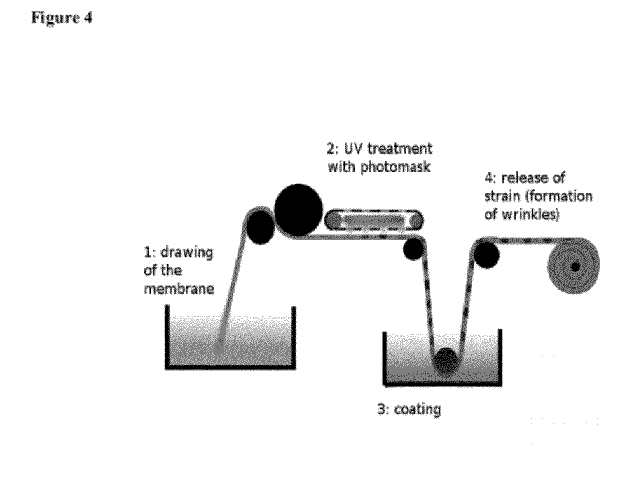

In certain embodiments, the invention relates to any one of the aforementioned methods, wherein the method is a continuous process. In certain embodiments, the invention relates to any one of the aforementioned methods, wherein the method is a continuous roll-to-roll process. In certain embodiments, the process resembles that depicted in FIG. 4. In certain embodiments, none of the steps in the inventive method involves contact with static parts (i.e., no mold casting, no micro-tooling).

### EXEMPLIFICATION

### Example 1

### Formation of a Patterned Material

### (A) PDMS Substrates

### (1) Preparation of PDMS Substrate

PDMS was used for the soft elastomeric substrate. It was prepared from 15 mL of a 10:1 mix of a poly(dimethylsiloxane) (PDMS) solution and a curing agent from Sigma-Aldrich. The PDMS solution was a mix by Dow Corning, prepared from the SYLGARD® 184 silicone elastomer kit, and contains 3 main components: (Dimethyl, methylhydrogen siloxane), (Dimethyl siloxane-dimethylvinyl-terminated) and (Dimethylvinylated and trimethylated silica).

After stirring, the solution was inserted in a low pressure environment for 10 to 20 min to remove the air bubbles. The solution was then poured onto a 150-mm diameter Petri dish. After an hour of curing time at 60° C., the solidified substrate is peeled off the dish, and cut into four 14-mm*38-mm samples. The thickness was 1 mm and, provided the sample were cut from the central region, the thickness was quite homogeneous (+−10%).

### (2) Characterization of the PDMS

PDMS was chosen for its mechanical characteristics: low Young's modulus, high strain at break, and low surface roughness achievable without any special attention. Hence PDMS will serve as an initial substrate, but it is important to note the applicability of the approach to any other materials.

A Dynamic mechanical analyzer, the Q800 from TA Instrument, was used to determine mechanical properties

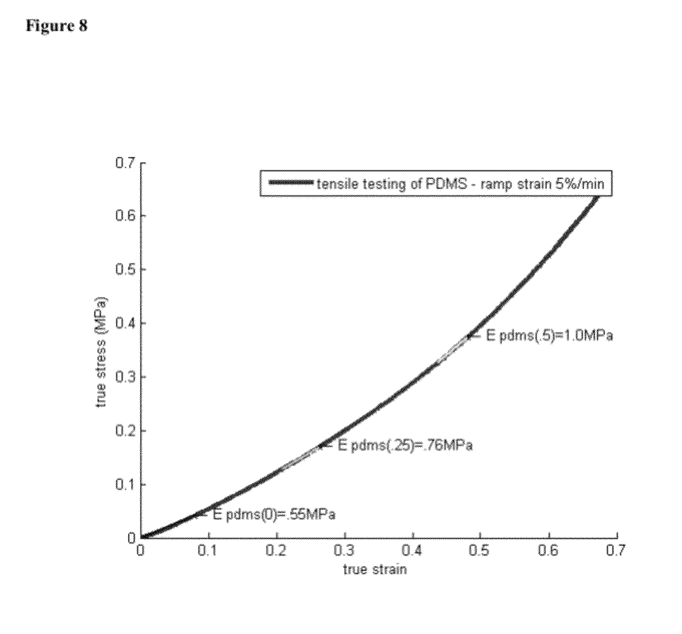

The first test imposed ramp in strain of 5%/min (the Q800 only controls the engineering strain rate), at a temperature of 28° C. and measured the force as a function of displacement. Matlab software was used to process the data. FIG. 8 represents one representative true strain/true stress history. The strain was increased until the sample broke.

PDMS, like most elastomeric materials is non-linear elastic; the tangent stiffness increases with applied strain.

Wrinkle formation can be influenced by the pre-strain of the substrate (before the deposition). The wrinkles form in the very beginning of the release of the strain, from the deformed configuration. For simplicity, the behavior of the substrate was characterized with only one parameter (the so-called initial stiffness or Young's modulus E_{S}). A more accurate analysis would take into account the non-linear behavior of the PDMS.

The Poisson ratio for this elastomer should be close to 0.5 (incompressible material). The strain at break is 0.6 to 0.7, mostly due to the propagation of surface edge cracks from one edge of the sample.

The tangent Young's modulus is measured at strains of 0, 0.25 and 0.5. Those measurements are repeatable within 10% and E_{PDMS}(0)=0.55 MPa, E_{PDMS}(0.25)=0.75 MPa and E_{PDMS}(0.5)=1.01 MPa.

As far as thermal properties are concerned, both a Dynamical Mechanical Analysis (DMA) and a measurement of the coefficient for thermal extension were performed.

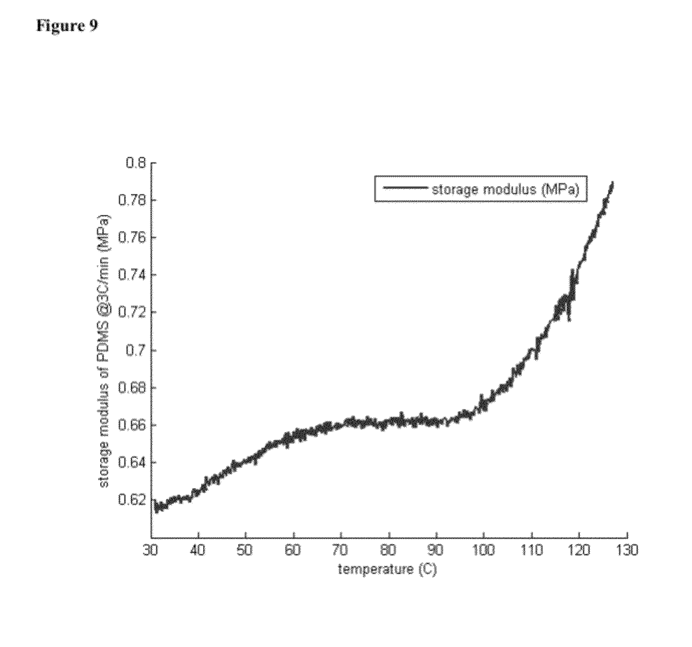

The storage and loss moduli are presented in FIG. 9 as a function of the temperature. The elastomer stiffens with the temperature, and relatively the energy absorbed by the material during one cycle is less and less important, showing the entropic nature of the modulus of rubbery material.

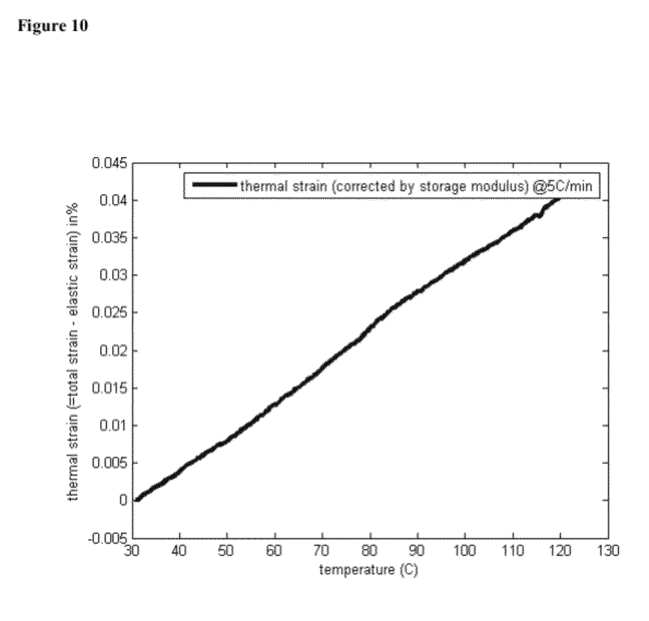

The extension of a strip of PDMS when heated above room temperature was measured. A pretension (15 kPa) was applied to the sample. This pretension was kept constant while the sample was heated. The elastic strain was not constant over the range of temperature considered (due to the variation of the stiffness with temperature), and had to be subtracted from the total strain to give the thermal strain. Hence, and neglecting viscoelastic effects the coefficient of thermal expansion was computed. This coefficient, corrected by the change in stiffness and the applied tension in the sample over the range of temperature, was pretty constant up to 80° C. and was close to 420×10⁻⁶K⁻¹. The resulting thermal strain versus temperature is represented in FIG. 10.

(B) Coating with EGDA
(1) Preparation for the iCVD Coating

(a) Plasma Treatment

The PDMS samples were then plasma treated to obtain a better bonding of the film to the substrate. Plasma treatment creates radicals at the surface of the membrane, which allowed the silane to adhere covalently to the substrate.

(b) Silane Evaporation

After plasma treatment, the membrane was placed in a low vacuum environment. Silane was then evaporated in this environment, and reacted with the radicals at the surface of the membrane. This treatment enhanced the adhesion of the EGDA coating.

(c) The Stretching Device.

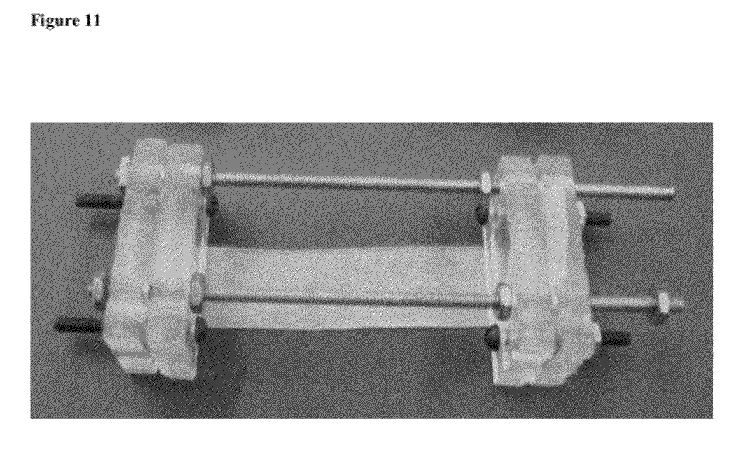

In order to deposit the coating on a stretched substrate, a system for tensioning the PDMS samples was designed. The final design and a photo are shown in FIG. 11. Two PVC jaws move along two long screws, while the clamping mechanism is actuated by two small screws on each clamp.

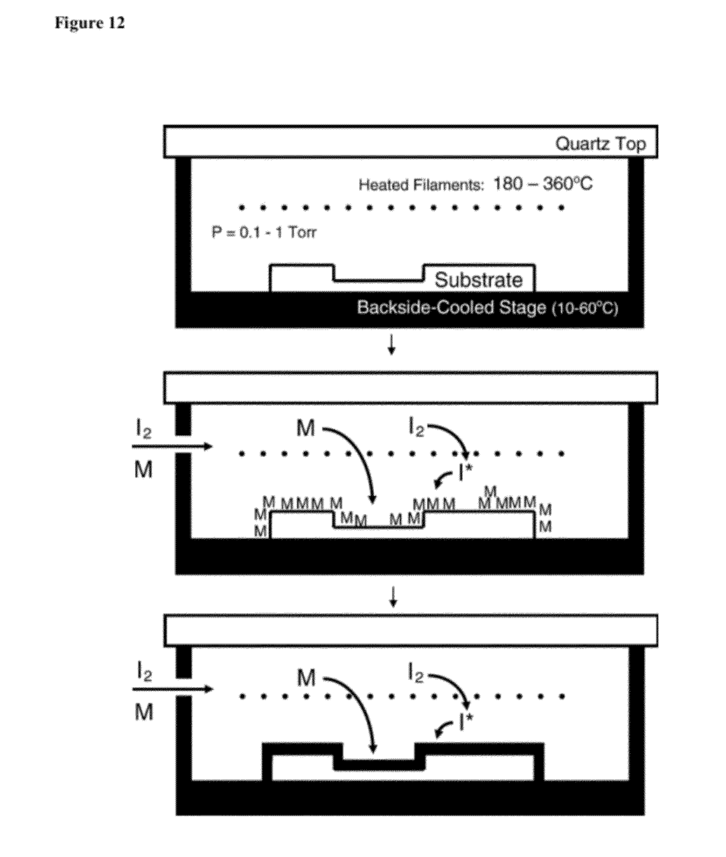

This design accommodates several needs:
The whole sample is maintained in contact with the bottom plate of the reactor, which is cooled down (see FIG. 12: iCVD coating technique. From FIG. 49 the “backside cooled stage”). It is really important to insure a good control of the temperature of the sample for the quality of the deposition (uniformity of the coating).
No metal parts directly touch the sample, to avoid conducting the heat of radiation from the filaments to the sample.
The linear motion of stretching is precise enough to control elongation to hundreds of microns. The maximum distance separating the two clamps is fixed to 50 mm.
   (2) iCVD Coating with EGDA

The iCVD (initiated Chemical Vapor Deposition) coating is a low energy coating technique.

During the coating deposition, several chemicals were brought in gaseous phase into a low pressure reactor. As they flowed through heated filaments, the initiated species (I₂ on FIG. 12) were decomposed into free radicals (I*) with minimal energy input, and then recombined with the monomer species (M) on the sample to form the polymer coating.

This technique has various advantages over other coating techniques. Mainly, a great number of different chemicals can be used. Furthermore, it requires only a minimal energy input, and the reaction path is better controlled, resulting in less damage to functional groups during deposition, even at high deposition rate.

### (3) Characterization of Mechanical Properties of the EGDA Hard Coating

In addition to the chemistry of the initiated species (I₂) and monomers (M), and the flux of those chemicals, the growth rate (or thickness increase of the film) was also controlled. This growth rate was measured in real time by a laser interferometer. This laser was pointed to a control wafer of silicon which was placed close to the sample. The growth rates on the sample and on the silicon were assumed to be similar.

The coating on the wrinkled samples was 1-μm thick.

In order to test the material properties, self-standing films of EGDA were also produced. Those films were thick enough to be self standing. The stress-strain profile of EGDA at room temperature was measured.

### (C) Releasing the Strain and Formation of the Wrinkles

Following iCVD, the strain was released to form the major wrinkles. As the substrate was pulled out of the clamps, the coating was put under compression and wrinkled into a sinusoidal shape. The wavelength of the sinusoid was found to be about 38 μm; this value corresponded to the mode of lower energy of the system determined by the thickness of the coating and the ratio of the stiffness of the coating to that of the substrate. The amplitude of the primary wave is controlled by the amount of stretch released during the formation of the wrinkles.

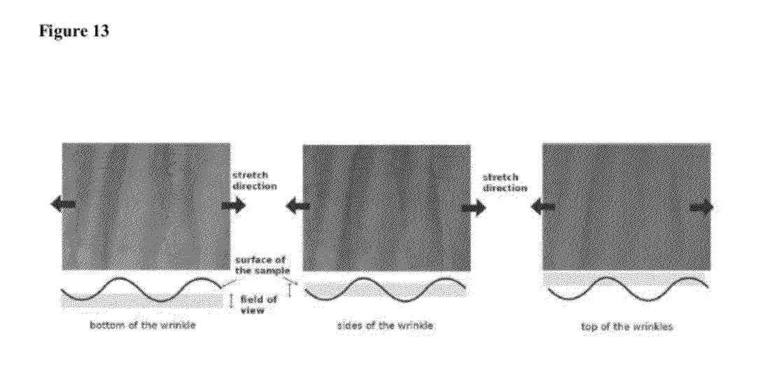

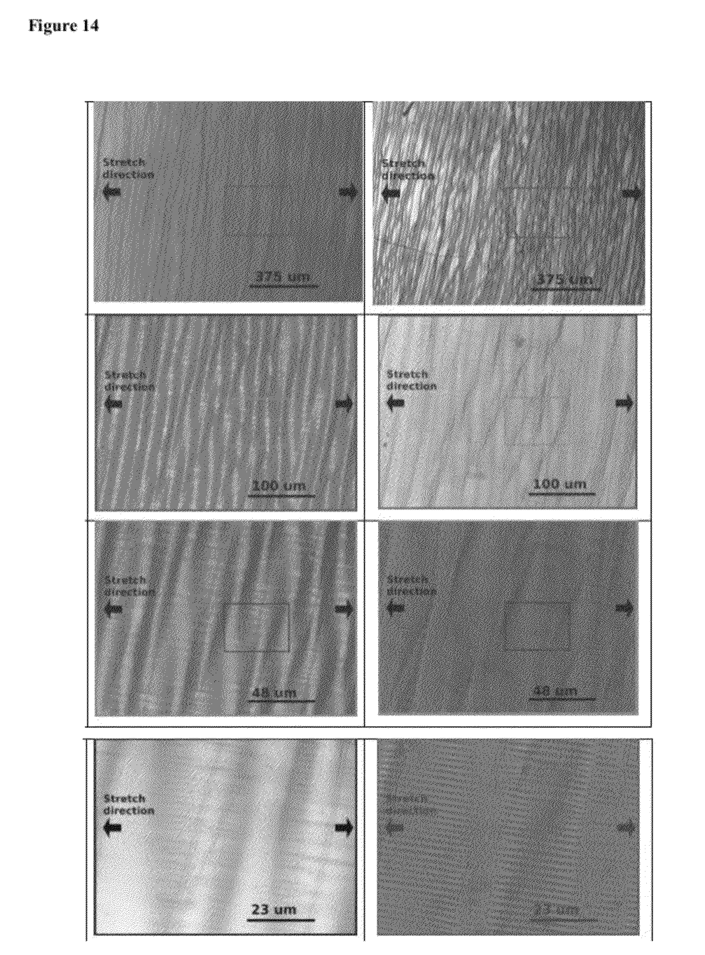

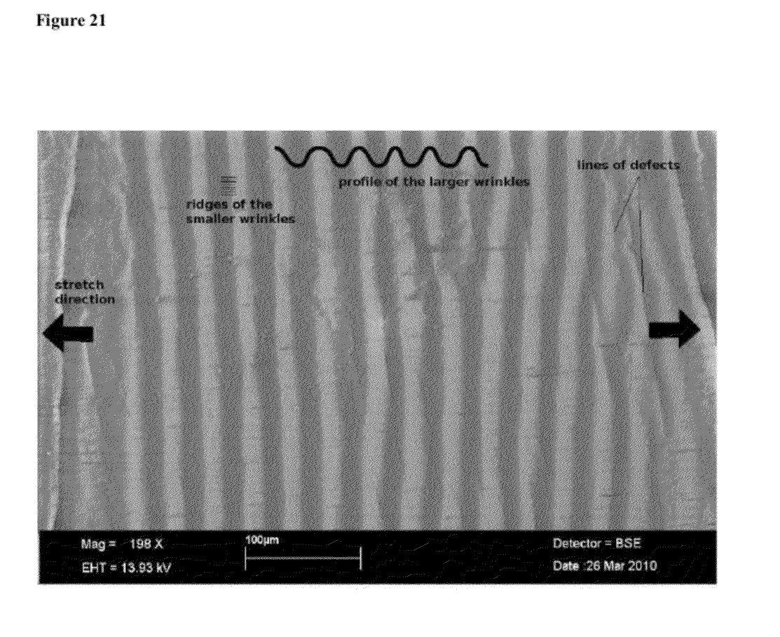

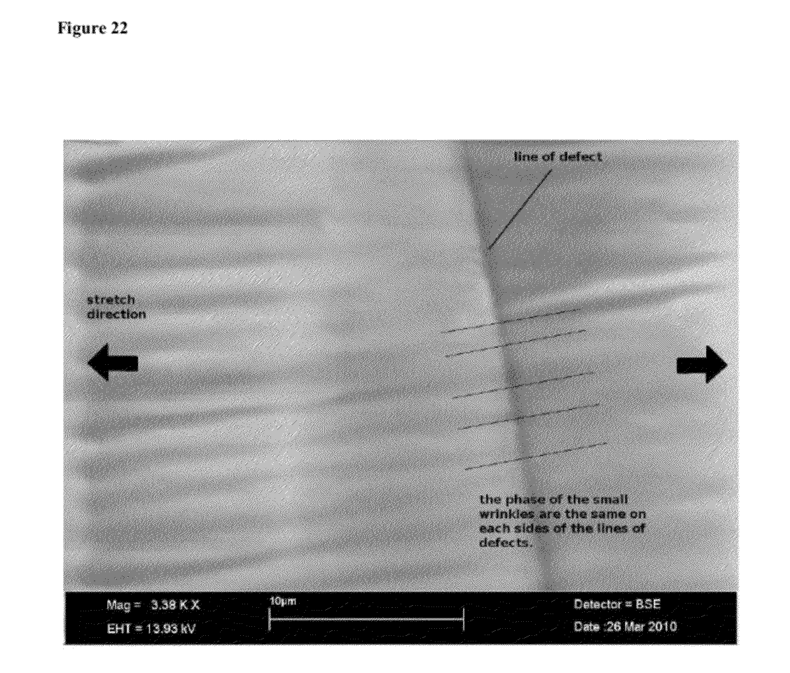

Perpendicular wrinkles associated with shorter wavelengths were also observed on the surface of the samples (see, e.g., FIG. 13, FIG. 14, FIG. 21, and FIG. 22). Not wishing to be bound by any particular theory, these wrinkles may have been formed before the deposition; the initial plasma treatment of the substrate increased the cross-link density, thereby forming a stiff skin on the surface of the substrate. As the substrate was stretched and put into clamps, a compressive strain develops in the direction perpendicular to the main stretch due to the Poisson effect. This results in the wrinkling of the stiff skin in the direction perpendicular to the main stretch direction. This wrinkling is still observable after deposition and release of the stretch. This demonstrates a first way to combine several patterns with different periodicities. An even easier technique may include partially releasing the stretch during deposition. If unnecessary, the secondary wrinkles may be eliminated by applying the plasma treatment to a stretched substrate.

Cracks that open perpendicularly to the main stretch direction were also observed. The cracks may be due to overstretching of the cross-linked skin layer of the substrate.

### Example 2

### Characterization of a Hard Coating on a Soft Substrate

### (A) Overview

The membranes prepared by the procedure outlined in Example 1 were characterized. Optical microscopy, along with an optical profilometer and a Scanning Electron Microscope were used to characterize the samples. The shape of the wrinkled membranes was characterized, and the measurement of wavelength obtained with each technique was compared. The profilometer was also used to measure to the amplitude of the wrinkles

### (B) Microscopy

Optical micrographs of the membrane were taken with a camera associated with a Nikon microscope. The horizontal dimensions on the microscope have been calibrated, with TEM grid Veeco 200 (pitch 125 μm).

Images are shown in both the transmitted light mode and in the reflected light mode. The transmitted light mode seemed to reduce the field of view and allowed focus on only a part of the sample (e.g., FIG. 13 (a) shows the focusing on the valley of the wrinkles while (c) is the same image focused on the peak of the wrinkles). This helps confirm that the surfaces were not flat, but had sinusoidal-like features of finite height. FIG. 13 shows this phenomena with a single image focuses on 3 different heights of the wrinkles.

The low magnification images (FIG. 14 top left, top right) clearly show the primary wrinkles of the longest wavelength, which run perpendicular to the stretch direction. Those wrinkles have a low wavelength and are not perfectly regular 34 μm (±10 μm). In this case, peaks and valleys of the sinusoid were distinguishable due to the finite depth of field; these were not obvious in the transmitted light mode.

At higher magnification, wrinkles perpendicular to the long wavelength wrinkles (i.e., aligned with the stretch direction) became apparent (FIG. 14 middle two rows). These wrinkles were of much shorter wavelength, just above 2.2 μm (±0.2 μm), and seemed to be more regularly spaced than the primary wrinkles

### (C) Optical White Light Profilometer

In order to measure the amplitude of the wrinkles, an optical profilometer was used (the noncontact Scanning White Light Interferometer NewView 5032 by Zygo). Based on the peak of maximum intensity of the fringes of interference, the profilometer generates a 3D image of the surface of the membrane. Depending on the lens (20× and 50×) and the magnification (0.4× to 2×) chosen, those images cover a surface from 70×50 μm² up to 800×600 μm². The horizontal resolution depends on the magnification and ranges from 30 nm to 300 nm, while the vertical resolution is under 0.1 nm. The main limitation of this technique is the difficulty of imaging tilted surfaces, since the light is not reflected on the sensor if the surface is not horizontal. Most peaks and valleys of the wrinkles can be imaged, but the rest of the pattern is undetected.

### (1) Measurement of Wavelength and Amplitude of the Wrinkles by Profilometry

The measurements via optical profilometry confirmed the qualitative microscopy observations for wrinkles on top of stretched membranes:
Long wrinkles run perpendicular to the direction of the stretch. Those wrinkles run all across the sample.
The small perpendicular wrinkles were also imaged. Their wavelength was much smaller than the long wrinkles, but also more regular than the wavelength of the large wrinkles (less statistical dispersion of these wavelengths). Furthermore, it was observed that the small wrinkles were not limited to one peak or one valley but extended on hundreds of microns in length.

### (2) Influence of the Strain

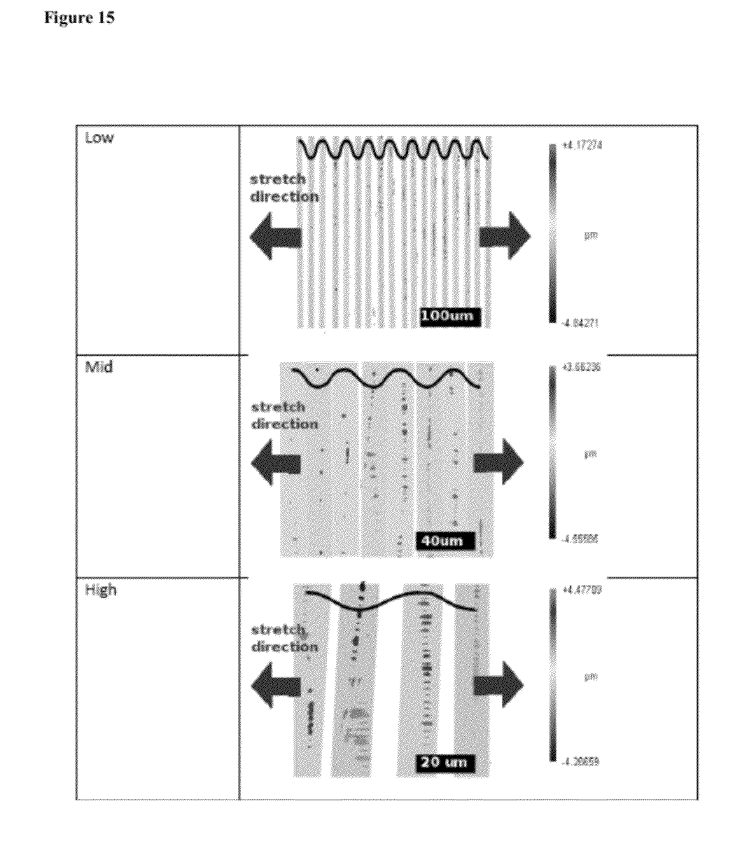

The influence of the pre-strain was studied qualitatively, with 3 different stretches: no strain; mid strain (15%) and high strain (40%) (FIG. 15). For each stretch, wrinkles of two different length scales were formed.

It should be noted that the higher the stretch, the higher the amplitude of the wrinkles, and the more tilted the surface of those wrinkles. Therefore, the stretched membranes were more difficult to image.

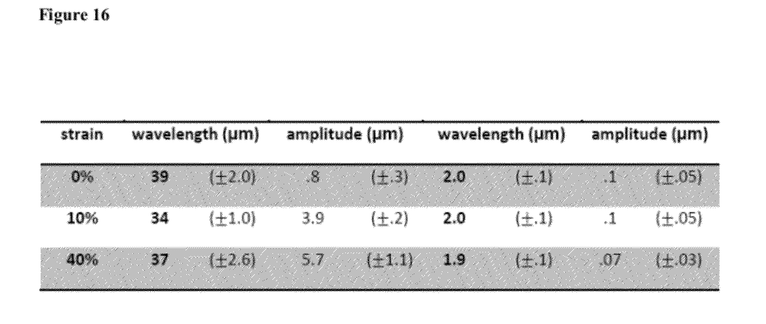

The measurements of wavelength and amplitude for the three levels of stretch in FIG. 16.

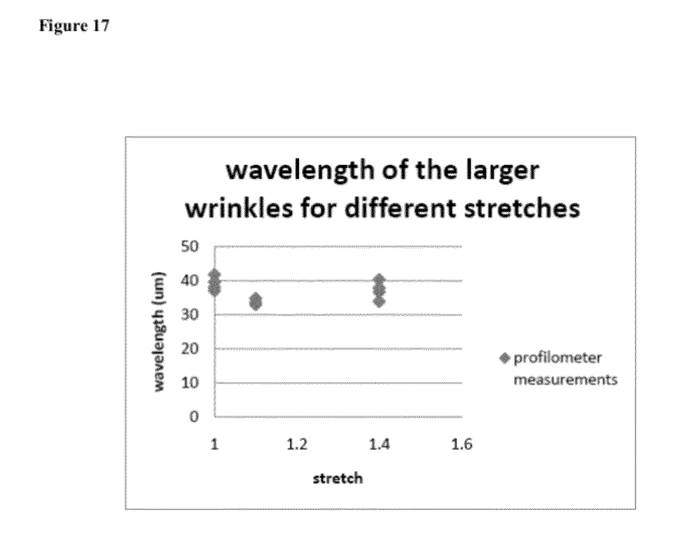

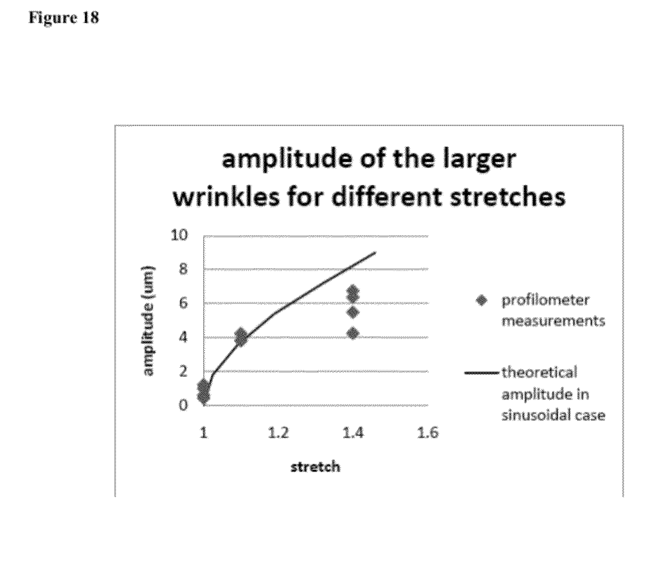

There was no significant influence of the stretch on the wavelength of the larger wrinkles (see FIG. 17), while the amplitude of the larger wrinkles were very dependent on the stretch (FIG. 18).

### (3) Influence of the Coating Thickness

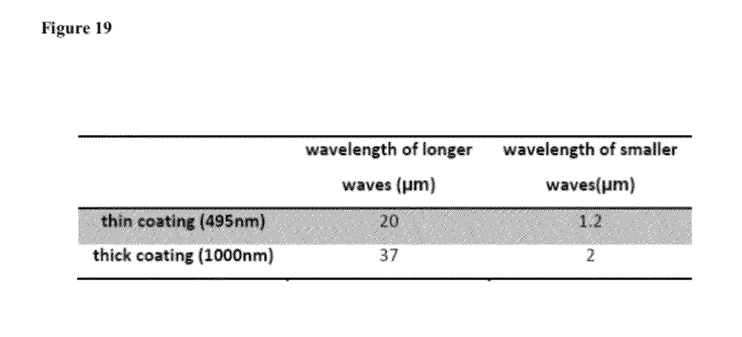

The influence of coating thickness was also studied experimentally. There was no significant difference in the shape for thinner coatings. The uniaxial straining of the membrane resulted in the sinusoid-like pattern. However, the wavelength of the sinusoids increased with the thickness of the coating. As summarize in FIG. 19, the thinner coating (495-nm thick) resulted in short wavelengths for both the long and short wrinkles, as compared to the thicker coating. The ratio of the wavelengths for both coating was close to the ratio of the coating thickness:

### (D) Scanning Electron Microscope

To complete the observation of this sample, Scanning Electron Microscopy was used. SEM provides a good visualization defects. The top right corner of FIG. 21 shows a representative line of defect, slightly tilted compared to the orientation of the main wrinkles.

It should be noted that the defects were crossed by the shorter wrinkles (i.e., the phase of the wrinkles is the same on both edges, which delimit the defect). This may indicate that the shorter wrinkles were formed prior to the defects.

To conclude definitely on the mechanism of formation of the defect in the wrinkles, further investigation is needed. Atomic Force Microscopy may help.

### Prophetic Example 3

### Different Patterns and Shapes of Wrinkles

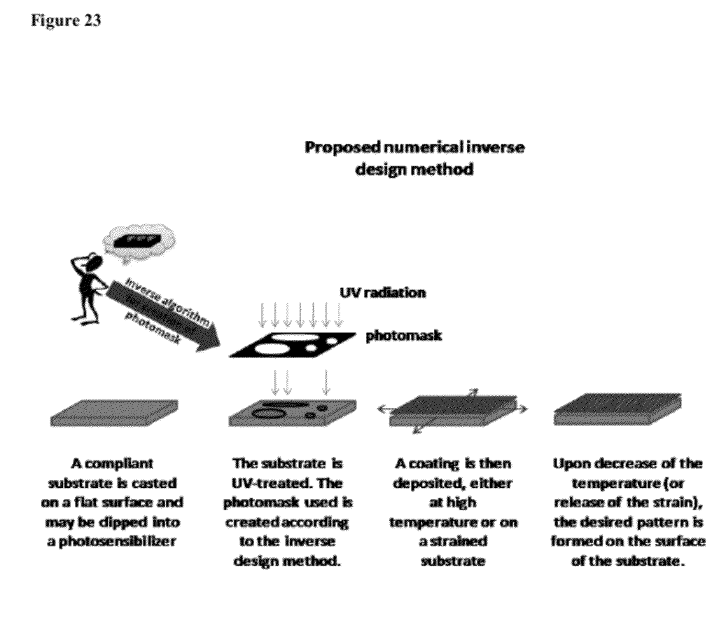

The pattern and the shape of the topography may be tuned by tuning the properties of the substrate. Various patterns have been made using a photolithographic approach. Similar patterns will be attempted using the inventive methods (FIG. 23).

### Prophetic Example 4

### Continuous Roll-to-Roll Process

Unlike conventional processes for patterning substrates (e.g., mold casting), another advantage of the inventive methods is that they can be made a truly continuous roll-to-roll process. An example of a continuous line using this method is shown in FIG. 4, where:
a compliant substrate can be obtained by drawing out of a polymer bath.
a photomask can be synchronized with the membrane, achieving a local stiffening of the substrate in a continuous process.
the straining can be achieved by tensioning the membrane or by raising the temperature.
the coating can be obtained by evaporation (e.g., iCVD . . . ) in a low-pressure section of this process, or even by dip coating.

### Prophetic Example 5

### Process Optimization

The sample preparation (precision of the material treatment, uniformity of the coating thickness, uniformity of material properties, and absence of cracks . . . ) should be better controlled. A first step could be to try and obtain very steady wrinkles in the unidirectional case.

The second step is to optimize the control of the material properties of the substrate. The experiments prove that it was possible to treat the PDMS to have two material properties (stiff regions and compliant ones). Instead, a continuum of material properties (for instance by replacing black and white masks by grayscale photo-masks) would expand the range of “possible topographies,” i.e., the shapes that can be created with this method. This set of “possible topographies” would also be extended by improving the “contrast” of the material properties (i.e., the gradient of material properties).

### Prophetic Example 6

### Permeation Properties of Substrate

PDMS is a dense substrate. In order to apply this technology to membrane filtration, without degrading the permeation properties of current membranes, a porous material should be used as the substrate. Substrates having a gradient in porosity could also be used.

### Prophetic Example 7

### Fouling Test

More studies on the anti-fouling properties of the substrates made by methods of the invention are needed. These tests will also help to further the understanding of fouling behavior.

### Example 8

The iCVD monomer precursor is ethylene glycol diacrylate (EGDA), which is dual functional in this application. First, since pEGDA is a highly cross-linked polymer, it participates in the wrinkling formation as the stiff layer (E=775 MPa). Second, since pEGDA is a derivative of poly(ethylene oxide), it increases the anti-fouling capability of the surface.

To increase the adhesion between the iCVD pEGDA and PDMS, a thin layer of vinyltrichlorosilane was attached to the PDMS prior to the deposition. The formation of the silane layer and the deposition of pEGDA were characterized by ATR, FT-IR and contact angle.

Monoaxial and biaxial stretching were performed to obtain different patterns. SEM and interferometry studies were used to determine the amplitude and wavelength of the wrinkles. According to equation 1, given the Young's moduli of pEGDA (E_{c}) and PDMS (Eₛ), the wavelength of the wrinkles (λ) can be controlled by the coating thickness (t).

$$λ ∝ {t ( \frac{{E}_{c}}{{E}_{s}} )}^{\frac{1}{3}} \\ A ∝ {t ( \frac{{ɛ}_{pre}}{{ɛ}_{c}} - 1 )}^{\frac{1}{2}} \qquad ( 1 )$$

In addition, the amplitude of the wrinkles A can also be controlled by the coating thickness and the ratio of the prestretching strain εₚᵣₑ to the critical wrinkling strain ε_{c}. It should be noted that Eq. (1) is effective for film undergoing small deformation.

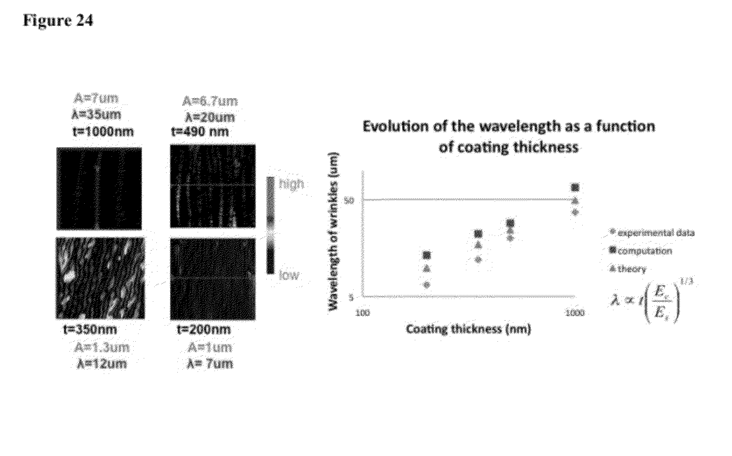

FIG. 24 gives the different wrinkle structures achieved by varying the pEGDA thickness from 200 nm to 1 μm and applying a monoaxial stretching. The wavelengths obtained were compared to simulation results and to theoretical values, and these three sets of data have a similar trend as shown in FIG. 24. The difference in the specific wavelength values could be accounted by an elongation factor, which will be studied in further experiments.

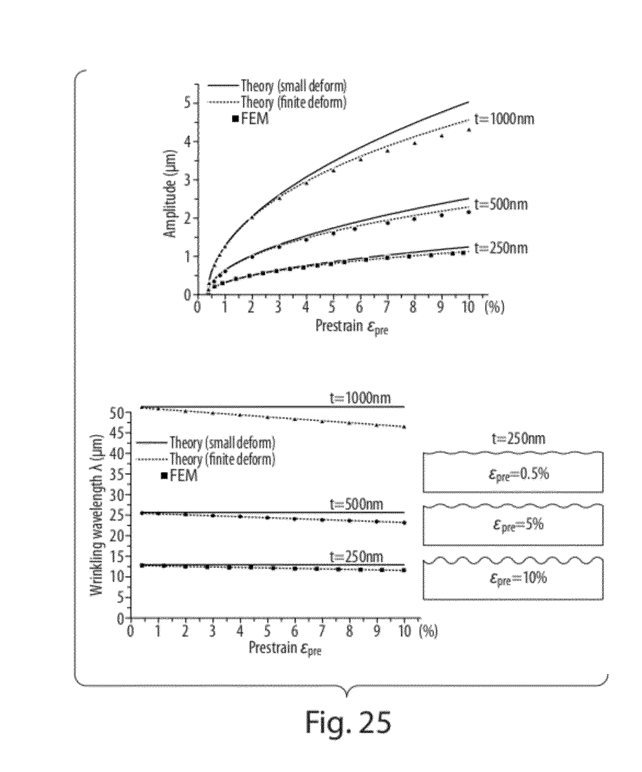

Another effective way to quantitatively manipulating the wrinkling wavelength and amplitude is through the control of prestreching strain εₚᵣₑ as shown in FIG. 25. Generally the small deformation theory in Eq. (1) overestimates the wrinkling amplitude and wavelength. When considering the large deformation, the effect of prestrain is included and Eq. (1) is modified as

$$\overline{λ} ∝ \frac{t}{1 + {ɛ}_{pre}} {( \frac{{E}_{c}}{{E}_{s}} )}^{\frac{1}{3}} \\ \overline{A} ∝ \frac{t}{1 + {ɛ}_{pre}} {( \frac{{ɛ}_{pre}}{{ɛ}_{c}} - 1 )}^{\frac{1}{2}} \qquad ( 2 )$$

FIG. 25 shows that for the amplitude and wavelength, Eq. (2) agree well with the numerical simulation when the prestrain is relatively large. The wrinkling morphologies for a coating thickness of 250 nm are shown in FIG. 25 at different prestrain, where the amplitude is found to increase whereas the wavelength decreases with εₚᵣₑ. These results will be further validated by future experiments.

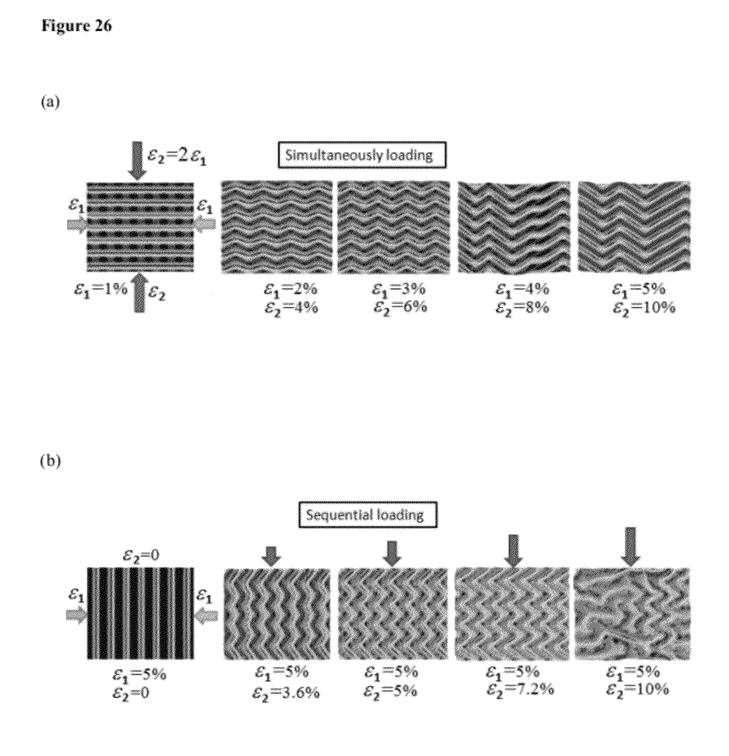

Other than the 1D sinusoidal wrinkling patterns in uni-axial compression and 2D herringbone patterns in equi-biaxial compression, more varieties of 2D patterns can be created through the non-equi-biaxial compression as well as the sequential release of the prestreching strain. FIG. 26 shows the simulated resulting wrinkling patterns with an applied strain ratio of 2 along the two directions 1-axis and 2-axis. When both strains (ε₁ and ε₂) are simultaneously applied to the two directions as shown in the top of FIG. 26, the patterns progressively evolve from a 1D sinusoidal pattern to a 2D modified herringbone pattern, where the straight wrinkles along 1-axis direction becomes buckled and the resulting wavelength increased with the applied strain whereas the wavelength along the 2-axis direction is kept constant. When both strains are sequentially applied, the similar transition from 1D to 2D patterns is observed. When ε₂ is increased to be equal with ε₁, the herringbone pattern is observed with a bending angle of 90°. The bending angle is decrease when ε₂ is further increased. A labyrinth pattern is observed when ε₂ is increased to 2ε₁, which is different from the ordered pattern created by simultaneous loading. These different wrinkled morphologies provide us more opportunities to investigate their fouling properties on their wrinkled surfaces. These results will be further explored in the future and validated by experiments.

### Example 9

### Anti-Fouling Properties

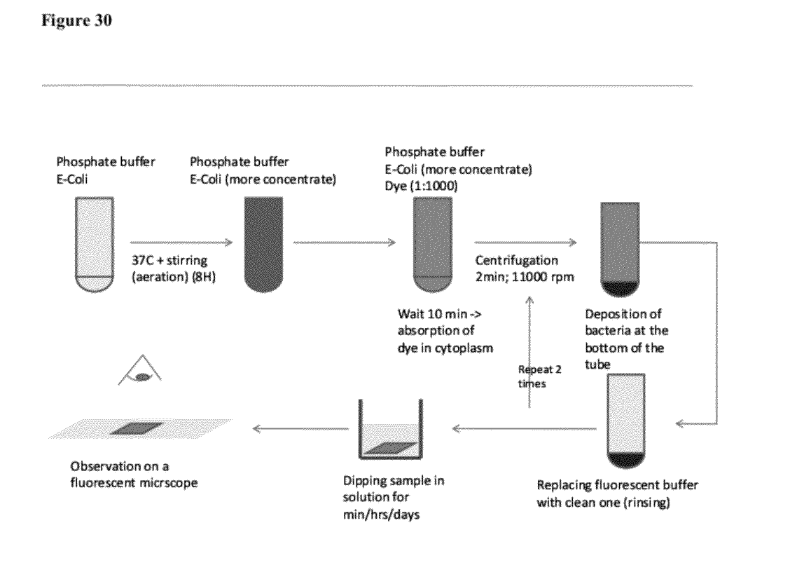

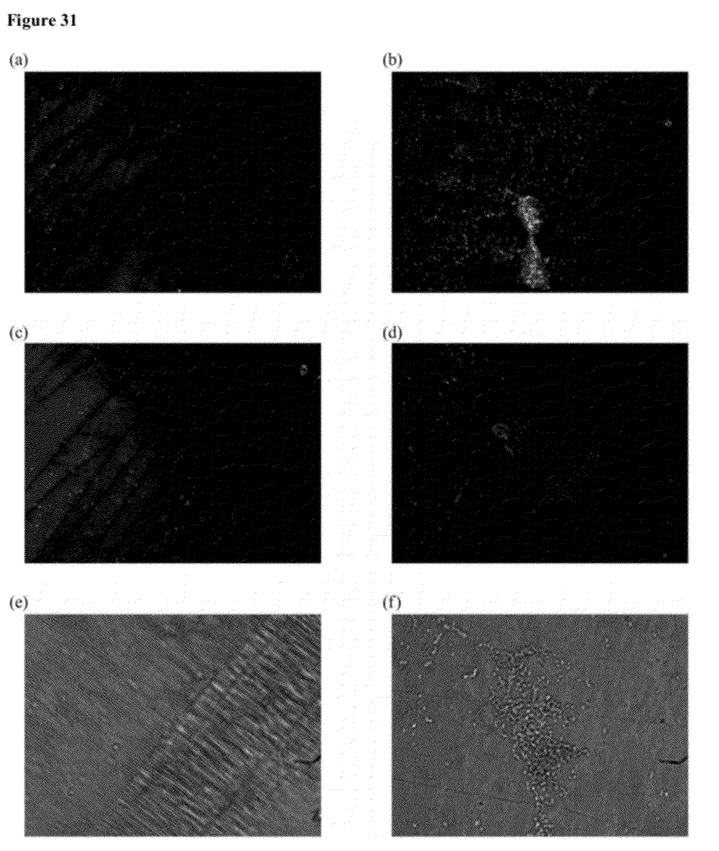

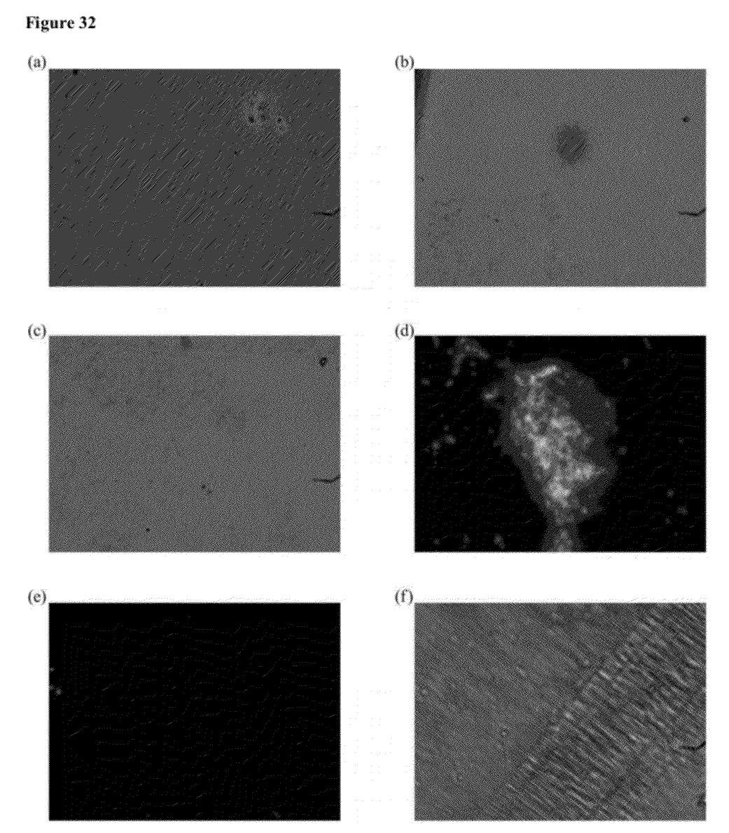

The anti-fouling properties of the substrates made by methods of the invention were observed via microscopy and fluorescence microscopy. See FIGS. 30-32.

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A composite material, wherein the composite material comprises a substrate with a coated surface; and the coated surface comprises a coating material.

2. The composite material of claim 1, wherein the coated surface comprises topography.

3. The composite material of claim 1, wherein the substrate comprises an elastomeric material, a thermoplastic material, or a thermoplastic-elastomeric material.

4. The composite material of claim 1, wherein the coating material is hard or stiff.

5. The composite material of claim 1, wherein the coating material comprises a polymer, a metal, or a ceramic.

6. The composite material of claim 1, wherein the thickness of the coating material is from about 0.005 μm to about 500 μm.

7. The composite material of claim 1, wherein the composite material is a membrane.

8. A method of making a composite material, comprising the steps of:
providing a substrate;
stretching the substrate, thereby forming a stretched substrate;
coating a surface of the stretched substrate with a material, thereby forming a stretched substrate with a coated surface;
releasing the stretch from the stretched substrate with a coated surface, wherein releasing the stretch causes the coated surface to buckle, thereby forming a composite material with a coated surface.

9. The method of claim 8, wherein the substrate is stretched in one dimension or in two dimensions.

10. The method of claim 8, wherein the substrate is stretched from about 0.01% to about 100%.

11. The method of claim 8, wherein the coated surface of the composite material comprises topography.

12. The method of claim 8, wherein the substrate comprises an elastomeric material, a thermoplastic material, or a thermoplastic-elastomeric material.

13. The method of claim 8, wherein coating the surface of the substrate comprises initiated chemical vapor deposition (iCVD) of a polymer in a deposition chamber.

14. The method of claim 13, wherein the pressure of the deposition chamber is from about 0.05 Torr to about 1.5 Torr.

15. The method of claim 8, wherein coating the surface of the substrate comprises contacting the surface with a polymer solution.

16. The method of claim 8, wherein the coating material is hard or stiff.

17. The method of claim 8, wherein the coating material comprises a polymer, a metal, or a ceramic.

18. The method of claim 8, wherein the thickness of the coating material is from about 0.005 μm to about 500 μm.

19. The method of claim 8, wherein the method is a continuous process.

20. The method of claim 8, wherein the method is a continuous roll-to-roll process.
